(19) United States
(12) Patent Application Publication
(10) Pub. No.: US 2022/0274563 A1
(43) Pub. Date: Sep. 1, 2022

(54) HEATER DEVICE, IMAGING DEVICE FOR VEHICLE AND HEATER DEVICE MANUFACTURING METHOD

(71) Applicants: TOKYO COSMOS ELECTRIC CO., LTD., Kanagawa (JP); PANAC CO., LTD., Minato-ku, Tokyo (JP)

(72) Inventors: Masashi KAJI, Kanagawa (JP); Takuya KARASAWA, Kanagawa (JP); Takashi WATANABE, Shizuoka (JP)

(21) Appl. No.: 17/632,122

(22) PCT Filed: Jul. 20, 2020
(86) PCT No.: PCT/JP2020/028168

§ 371 Date: Feb. 1, 2022

(30) Foreign Application Priority Data
Aug. 2, 2019 (JP) 2019-142986

(51) Int. Cl. B60S 1/02; B60R 11/00; H05B 3/06; H05B 3/84; B32B 7/12; B32B 37/12; B32B 3/08; B32B 17/10; B32B 27/36

(52) U.S. Cl. CPC B60S 1/026; B60R 11/00; H05B 3/06; H05B 3/84; B32B 7/12; B32B 37/12; B32B 3/08; B32B 17/10; B32B 27/36; B60R 11/04

(57) ABSTRACT

A heater device is provided with: a transparent substrate; a heating wire arranged on a first face side of the transparent substrate; and a transparent adhesive layer formed on the first face side of the transparent substrate so as to cover the heating wire. The values of the thickness and viscosity of the adhesive layer are selected such that, when the heater device is affixed onto a windshield by means of the adhesive layer, a wedge angle of a concave portion that is formed on the transparent substrate in the vicinity of the heating wire due to a height of the heating wire is no greater than 0.1°.

### TECHNICAL FIELD

The present disclosure relates to a heater apparatus, a vehicle image capturing apparatus, and a manufacturing method of a heater apparatus.

### BACKGROUND ART

In the related art, a heater apparatus that is attached to a window pane or the like of a vehicle to heat an object attached to the window pane or the like is known (see, for example, PTL 1).

The heater apparatus of this type is used as an apparatus that performs defrosting and/or antifogging of the window pane in the monitoring region in an in-vehicle radar and/or a vehicle image capturing apparatus that monitors the vehicle outside through the window pane, for example.

PTL 1 discloses a sheet-like heater apparatus directly bonded to the windshield of a vehicle to heat the windshield. The image capturing apparatus captures an image in front of the vehicle by receiving light from the vehicle outside through the windshield and the heater apparatus.

### CITATION LIST

### Patent Literature

PTL 1
Japanese Patent Application Laid-Open No. 2017-147031

### SUMMARY OF INVENTION

### Technical Problem

Incidentally, as described above, when the sheet-like heater apparatus directly affixed to the windshield to heat the windshield is used, the image capturing apparatus obtains the captured image by receiving image-capturing light transmitted through the heater apparatus. Here, the image captured by the image capturing apparatus is used for the vehicle travel control and the like, and is therefore need to have high quality as much as possible with the negative influence of the heater apparatus eliminated as much as possible.

In view of this, an object of the present disclosure is to provide a heater apparatus, a vehicle image capturing apparatus, and a manufacturing method of a heater apparatus that can obtain a high-quality captured image.

### Solution to Problem

A heater apparatus of an embodiment of the present disclosure includes is an apparatus with a sheet shape configured to be affixed to one surface of a transparent member, the heater apparatus including: a transparent substrate; a heat wire disposed on a first surface side of the transparent substrate; and a bonding layer with a transparency formed on the first surface side of the transparent substrate to cover the heat wire. A thickness and an elastic modulus of the bonding layer are set to values at which a wedge angle of a protrusion is 0.1° or smaller, the protrusion being formed in a region around the heat wire at the transparent substrate due to a height of the heat wire when the heater apparatus is affixed to one surface of the transparent member through the bonding layer.

A vehicle image capturing apparatus of an embodiment of the present disclosure includes: the heater apparatus according to claim 1; and an image capturing apparatus configured to obtain a captured image by receiving image-capturing light transmitted through the heater apparatus.

A manufacturing method of an embodiment of the present disclosure is a manufacturing method of a heater apparatus with a sheet shape configured to be affixed to one surface of a transparent member, the method comprising: forming a heat wire on a first surface side of a transparent substrate; forming a bonding layer with a transparency on the first surface side of the transparent substrate so as to cover the heat wire; and affixing the transparent substrate where the heat wire and the bonding layer are formed, to one surface of the transparent member through the bonding layer. A thickness and an elastic modulus of the bonding layer are set to values at which a wedge angle of a protrusion is 0.1° or smaller, the protrusion being formed in a region around the heat wire at the transparent substrate due to a height of the heat wire when the transparent substrate where the heat wire and the bonding layer are formed is affixed to one surface of the transparent member through the bonding layer.

### Advantageous Effects of Invention

According to the present invention, the wedge angle of a protrusion formed in a region around the heat wire in the transparent substrate due to the height the heat wire when the heater apparatus is affixed to one surface of transparent member is set to 0.1° or smaller, and thus the formation of flare and/or distortion due to a lens effect in a region around the heat wire in the captured image can be suppressed, and as a result, a high-quality captured image can be obtained.

### BRIEF DESCRIPTION OF DRAWINGS

FIG. 1 is sectional views including a state where a transparent substrate at a portion corresponding to a heat wire protrudes, FIG. 1A is a diagram illustrating a heat wire disposed on a transparent substrate, FIG. 1B is a diagram illustrating a state where an irregular surface corresponding to a pattern of a heat wire appears at a surface of a bonding layer, FIG. 1C is a diagram illustrating a state where the transparent substrate at a position of the heat wire protrudes to the surface side when the heater apparatus is affixed to the windshield, and FIG. 1D is a schematic light path diagram illustrating a state of light emission at a protruding portion of transparent substrate 10;

FIG. 2 is a schematic view of an experiment;

FIG. 3 is an enlarged view of a region around a protrusion of the heater apparatus for describing a wedge angle;

FIG. 4 is a diagram illustrating a relationship between the wedge angle of the protrusion, the pointer length and the flare length;

FIG. 5 is a diagram illustrating a relationship between the thickness of the bonding layer and the flare length;

FIG. 6 is a diagram illustrating a relationship between the thickness of the bonding layer and the wedge angle;

FIG. 7 is a schematic sectional view illustrating an exemplary state where the heater apparatus is attached;

FIG. 8 is a plan view illustrating a wiring pattern of the heat wire of the heater apparatus;

FIG. 9 is sectional views illustrating a configuration of a heater apparatus according to Embodiment 1 and a manufacturing process, FIG. 9A is a diagram illustrating a heat wire disposed on a transparent substrate, FIG. 9B is a diagram illustrating a state where a protrusion corresponding to a pattern of the heat wire appears in a surface of a bonding layer, and FIG. 9C is a diagram illustrating a state where the heater apparatus of the embodiment is affixed to the windshield;

FIGS. 10A to 10D illustrate captured images obtained with bonding layers with thicknesses of 50 μm, 100 μm, 250 μm, and 350 μm, respectively; and

FIG. 11 is sectional views illustrating a configuration of a heater apparatus and a manufacturing process according to Embodiment 2, FIG. 11A is a diagram illustrating a state where a heat wire is disposed on a transparent substrate, FIG. 11B is a diagram illustrating a state where a protrusion corresponding to a pattern of a heat wire appears in a surface of a bonding layer, and FIG. 11C is a diagram illustrating a state where the heater apparatus of the embodiment is affixed to the windshield.

### DESCRIPTION OF EMBODIMENTS

### <1> Background to Invention

Before the description of the embodiments, a background to the invention is described.

The inventors of the present invention noticed that when a sheet-like heater apparatus including a heat wire is affixed to a vehicle windshield and an image is captured using a camera through the heater apparatus, distortion and/or a flare phenomenon (a phenomenon in which the shape of a point light source appears in a vertically extended state, not in a point) is caused in the captured image in the region around the heat wire.

As a result of a study about the cause of the distortion and the flare phenomenon, the present inventors first confirmed that the transparent substrate where the heat wire is formed is in a shape with irregularity along the pattern of the heat wire.

Next, as a result of a study about the cause of the irregularity, it was confirmed that the reason for the irregularity is that the sheet-like bonding layer (which may be referred to as adhesive layer) affixed to the transparent substrate to cover the heat wire for affixing the heater apparatus to the windshield is pressure bonded (affixed) to the windshield, the transparent substrate at the portion corresponding to the heat wire protrudes due to the pressure bonding force.

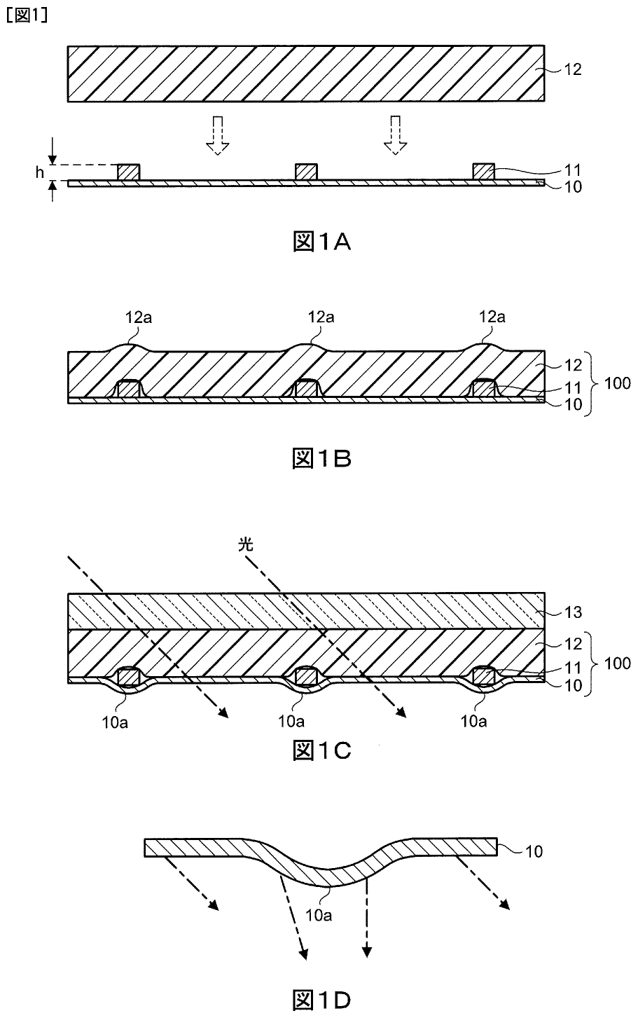

This state is illustrated in FIG. 1. As illustrated in FIG. 1A, heat wire 11 is disposed on transparent substrate 10, and transparent bonding layer 12 is bonded on the first surface of transparent substrate 10 so as to cover heat wire 11. The bonding layer is, for example, a double-sided tape. Then, protrusion 12a corresponding to the pattern of heat wire 11 is formed at the surface of bonding layer 12 as illustrated in FIG. 1B. Next, by pressing the surface side of transparent substrate 10 with the surface including protrusion 12a facing the glass surface of windshield 13, heater apparatus 100 composed of transparent substrate 10, heat wire 11 and bonding layer 12 is affixed to windshield 13.

FIG. 1C is a diagram illustrating a state where heater apparatus 100 is affixed to windshield 13. As is clear from FIG. 1C, protrusion 10a is formed when transparent substrate 10 corresponding to the position of heat wire 11 protrudes to the surface side. Protrusion 10a is formed when protrusion 12a of bonding layer 12 is pushed by the glass surface and transparent substrate 10 on the opposite side protrudes. That is, protrusion 12a of bonding layer 12 is transferred to transparent substrate 10 as a result of the pressing.

FIG. 1D is a schematic light path diagram illustrating a state of light emission at protrusion 10a of transparent substrate 10. Note that the light path illustrated in FIGS. 1C and 1D illustrates only the variation of the emission direction from transparent substrate 10, and the light refraction state at other portions is omitted for the purpose of simplifying the drawings. As is clear from FIG. 1D, when transparent substrate 10 at the position of heat wire 11 protrudes to the surface side, light entered from windshield 13 is emitted from transparent substrate 10 in different directions in a region around heat wire 11 due to the lens effect. As a result, distortion and/or flare is caused in the captured image in a region around heat wire 11.

Further, the present inventors conducted an experiment to examine the influence of protrusion 10a formed in transparent substrate 10 on the captured image.

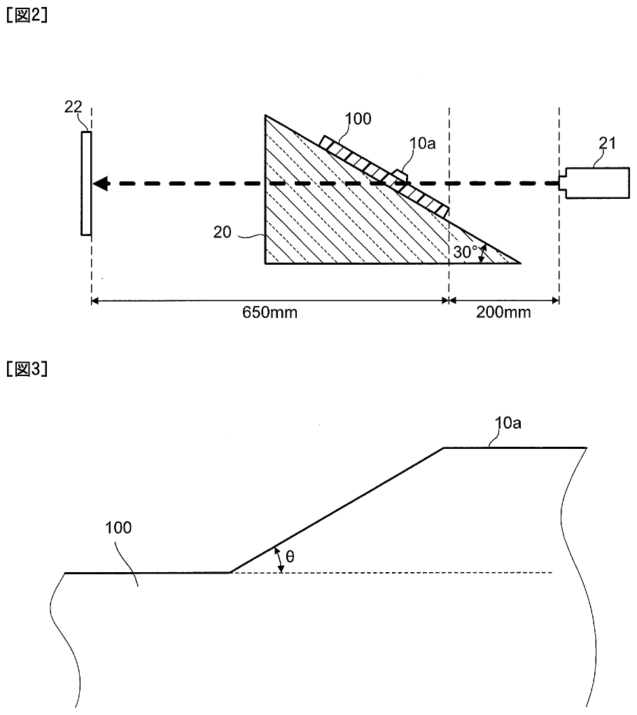

FIG. 2 is a diagram illustrating an overview of the experiment. A sample of heater apparatus 100 was affixed on the surface of glass stand 20 simulating a windshield. The inclination angle of an inclined surface of glass stand 20 where heater apparatus 100 as a sample is affixed was set to 30 degrees to simulate the inclination of a windshield. FIG. 3 is an enlarged view of a region around protrusion 10a (corresponding to protrusion 10a of FIG. 1) of heater apparatus 100. Protrusion 10a has a substantially trapezoid shape, and is raised at a wedge angle θ from a flat surface.

Laser light was applied from laser pointer 21 toward heater apparatus 100 as the sample, and the transmitted light projected on screen 22 was observed. Here, the length of the laser light of laser pointer 21 (hereinafter referred to as “pointer length”), and the length of the flare appeared in a region around it was observed.

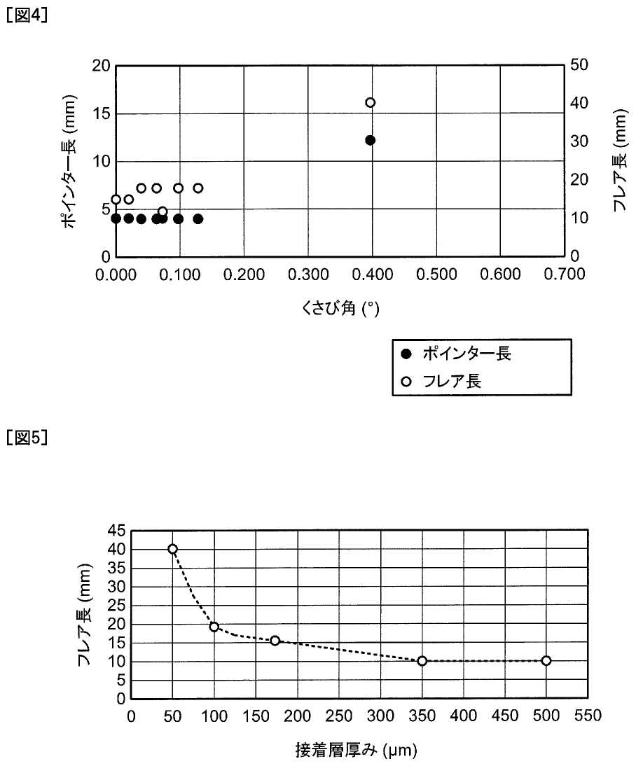

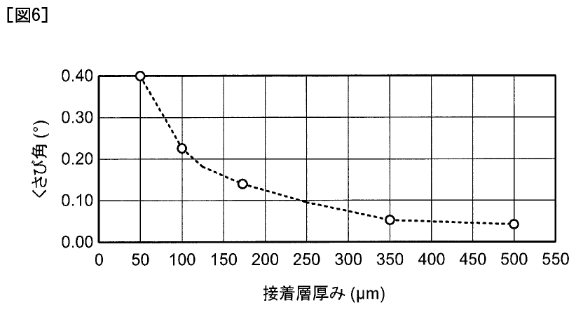

FIGS. 4 to 6 illustrate an experiment result obtained through an experiment conducted on a plurality of heater apparatuses 100. FIG. 4 illustrates a relationship between wedge angle θ of protrusion 10a, the pointer length and the flare length. FIG. 5 illustrates a relationship between the thickness of bonding layer 12 of heater apparatus 100 and the flare length. FIG. 6 illustrates a relationship between the thickness of bonding layer 12 of heater apparatus 100 and wedge angle θ.

Here, protrusion 10a may not have a trapezoid shape as illustrated in FIG. 3, and actually has a shape with a curve in practice as illustrated in FIGS. 1C and 1D. That is, FIG. 3 illustrates a model intended for easy description. Essentially, wedge angle θ in the specification is an angle between the flat surface of transparent substrate 10 and a straight line connecting the start point (i.e., the start point of the raising) of protrusion 10a and the vertex (i.e., the most raised point) of protrusion 10a.

Here, if a flare is generated, such a flare is obtrusive and leads to reduction of the quality of the captured image, and it is naturally preferable that the flare be not generated, or the flare length be small even if the flare is generated. It is conceivable that the cause of the generation of the flare is the refraction due to the formation of protrusion 10a. That is, a light beam is refracted by the wedge prism effect due to the irregularity, the light point is linearly extended, and the flare is generated.

As can be seen from FIG. 4, the flare length is short when wedge angle θ is 0.1° or smaller, but the flare length is abruptly lengthened when wedge angle θ is greater than 0.1°.

In addition, as can be seen from FIG. 5, the flare length is short when the thickness of bonding layer 12 is greater than 100 μm, but the flare length is abruptly lengthened when the thickness of bonding layer 12 is 100 μm or smaller.

Further, as can be seen from FIG. 6, the greater the thickness of bonding layer 12, the smaller the wedge angle θ.

From these experiment results, the flare length can be suppressed by setting wedge angle θ of protrusion 10a to 0.1° or smaller. Wedge angle θ can be set to 0.1° or smaller by setting the thickness of bonding layer 12 to 250 μm or greater (see FIG. 6). Here, with reference to FIG. 5, the flare length can be suppressed when the thickness of bonding layer 12 is 100 μm or greater. That is, the flare length can be suppressed by setting the thickness of the bonding layer to 100 μm or greater, and the flare length can be more reliably suppressed by setting the thickness of the bonding layer to 250 μm or greater. It should be noted that the shape of protrusion 10a, and in turn, the size of wedge angle θ is influenced not only by the thickness of bonding layer 12, but also by the elastic modulus of bonding layer 12. Therefore, it suffices to set the thickness and elastic modulus of bonding layer 12 to values at which the wedge angle of protrusion 10a is 0.1° or smaller.

Through the above-described examination, the inventors of the present invention achieved the present invention.

A feature of the present invention is that the thickness and/or elastic modulus of bonding layer 12 is set to a value at which when heater apparatus 100 is affixed to the glass surface, the wedge angle of the protrusion formed in transparent substrate 10 in a region around heat wire 11 due to the height of heat wire 11 is 0.1° or smaller.

An embodiment of the present invention is described below with reference to the accompanying drawings. Note that in the specification and drawing, the components having the virtually identical function are denoted with the same reference numerals to omit the overlapping descriptions.

### <2> Embodiment 1

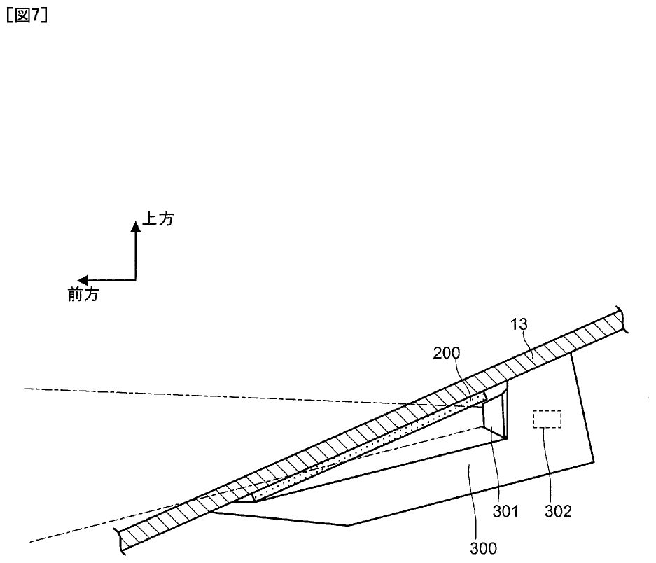

FIG. 7 is a schematic sectional view illustrating an exemplary state where heater apparatus 200 according to the present embodiment is attached. FIG. 7 illustrates an upper part of windshield 13 of the vehicle. Note that windshield 13 is extended and tilted at approximately 20 degrees to approximately 45 degrees with respect to the horizontal direction.

Heater apparatus 200 has a sheet-like shape. To be more specific, heater apparatus 200 is a planar heating element including a heat wire, and is affixed to windshield 13 on the vehicle inside to perform defrosting and/or antifogging of windshield 13 by warming windshield 13 and/or the surrounding atmosphere.

Imaging unit 300 is attached at a vehicle inside position corresponding to heater apparatus 200. Imaging unit 300 includes image-capturing section 301 and image processing section 302 that performs image processing on the image captured by image-capturing section 301. The image of the vehicle outside obtained by imaging unit 300 is provided to vehicle control ECU (not illustrated) that controls the vehicle, for example.

Heater apparatus 200 is disposed in the image-capturing direction of image-capturing section 301, and image-capturing section 301 receives light from the vehicle outside through windshield 13 and heater apparatus 200 and captures an image in front of the vehicle. Note that the dashed line in the drawing represents the image-capturing region.

Heater apparatus 200 and imaging unit 300 make up the vehicle image capturing apparatus of the present embodiment.

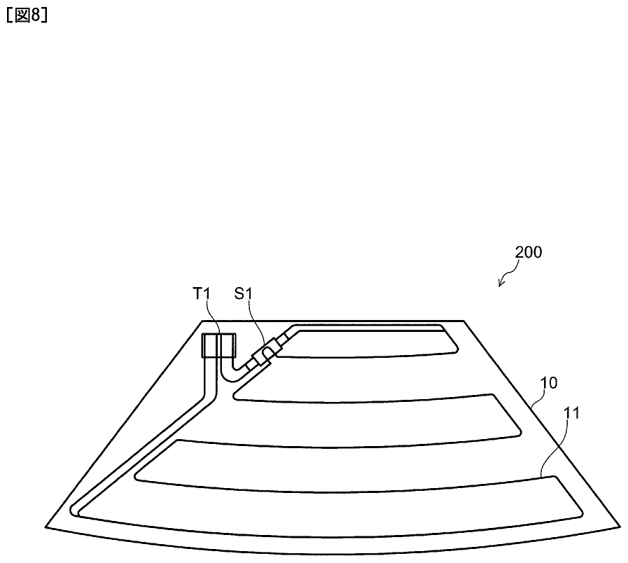

FIG. 8 is a plan view illustrating a wiring pattern of a heat wire of heater apparatus 200. In heater apparatus 200, heat wire 11 is disposed on transparent substrate 10. Heat wire 11 is connected to power source supply terminal T1. In addition, heat wire 11 is connected to PTC thermistor S1. PTC thermistor S1 prevents overheat and overcurrent of heat wire 11.

FIG. 9, in which portions corresponding to FIG. 1 are denoted with the same reference numerals, is a diagram illustrating a configuration and a manufacturing process of heater apparatus 200 according to the present embodiment.

First, as illustrated in FIG. 9A, heat wire 11 is disposed on transparent substrate 10, and transparent bonding layer 201 is bonded on the first surface of transparent substrate 10 so as to cover heat wire 11. Transparent substrate 10 is a polyethylene terephthalate (PET) film, for example. For transparent substrate 10, a substrate with a high transparency as much as possible and a flexibility that can follow the shape of the glass surface of the vehicle is used.

In the present embodiment, bonding layer 201 is a double-sided tape whose main component is acrylic adhesive. In other words, bonding layer 201 is a sheet-like transparent bonding layer with a uniform thickness. Bonding layer 201 is different from bonding layer 12 of FIG. 1 in thickness. For example, bonding layer 12 of FIG. 1 has a thickness of 50 μm, whereas bonding layer 201 of the present embodiment has a thickness of 350 μm.

When bonding layer 201 is bonded, the surface of bonding layer 201 becomes irregular surface 201a corresponding to the pattern of heat wire 11 as illustrated in FIG. 9B. Next, by pressing the surface side of transparent substrate 10 with irregular surface 201a facing the glass surface of windshield 13, heater apparatus 200 composed of transparent substrate 10, heat wire 11 and bonding layer 201 is affixed to windshield 13.

FIG. 9C is a diagram illustrating a state where heater apparatus 200 is affixed to windshield 13. As is clear from comparison with FIG. 1C, transparent substrate 10 at the position of heat wire 11 is not protruded to the surface side. The reason for this is that even when protrusion 201a of bonding layer 201 is pushed by the glass surface, the adhesive agent corresponding to protrusion 201a disperses in bonding layer 201 and the pressure force does not reach the surface of transparent substrate 10 since bonding layer 201 is sufficiently thick.

As a result, in heater apparatus 200 of the present embodiment, since the protrusion due to height h of heat wire 11 of transparent substrate 10 is not formed, the emission angle of light from transparent substrate 10 is uniform and distortion and/or flare in the captured image in a region around heat wire 11 can be suppressed.

As described above, according to the present embodiment, the thickness of bonding layer 201 is increased enough to prevent the formation of the protrusion due to height h of heat wire 11 at transparent substrate 10 in a region around heat wire 11 when heater apparatus 200 is affixed to the glass surface through bonding layer 201. Thus, the distortion and/or flare due to the lens effect in the captured image in a region around heat wire 11 is suppressed, and heater apparatus 200 that can obtain a high-quality captured image can be achieved.

Note that in practice, whether the protrusion due to height h of heat wire 11 of transparent substrate 10 is formed depends on (i) the thickness of bonding layer 201, (ii) the elastic modulus of bonding layer 201, (iii) height h of heat wire 11, and (iv) the flexibility of transparent substrate 10. To be more specific, the above-mentioned protrusion is more likely to be formed as the thickness of bonding layer 201 decreases, the elastic modulus of bonding layer 201 increases, height h of heat wire 11 increases, and the flexibility of transparent substrate 10 increases.

Here, reducing the height of heat wire 11 and reducing the flexibility of transparent substrate 10 are not realistic as a method for reducing the above-mentioned protrusion. The reason for this is that if the height of heat wire 11 is reduced, the resistance value of heat wire 11 is increased, thus making it difficult to perform the desired heater control. In addition, if the flexibility of transparent substrate 10 is reduced, transparent substrate 10 may not follow the shape of the glass surface, and in turn, heater apparatus 200 may be easily removed from glass surface.

In view of this, it is preferable to set the thickness and/or elastic modulus of bonding layer 201 to values at which the protrusion due to height h of heat wire 11 is not formed at transparent substrate 10 in a region around heat wire 11 when heater apparatus 200 is affixed to the glass surface through bonding layer 201. Furthermore, while the formation of the protrusion is prevented in the embodiment, this is not limitative, and it suffices to set the thickness and elastic modulus of bonding layer 201 and heater apparatus 200 to values at which when heater apparatus 200 is affixed to windshield 13, the wedge angle of the protrusion formed due to the height of heat wire 11 is 0.1° or smaller. In other words, the example of the embodiment is an example in which wedge angle is 0°.

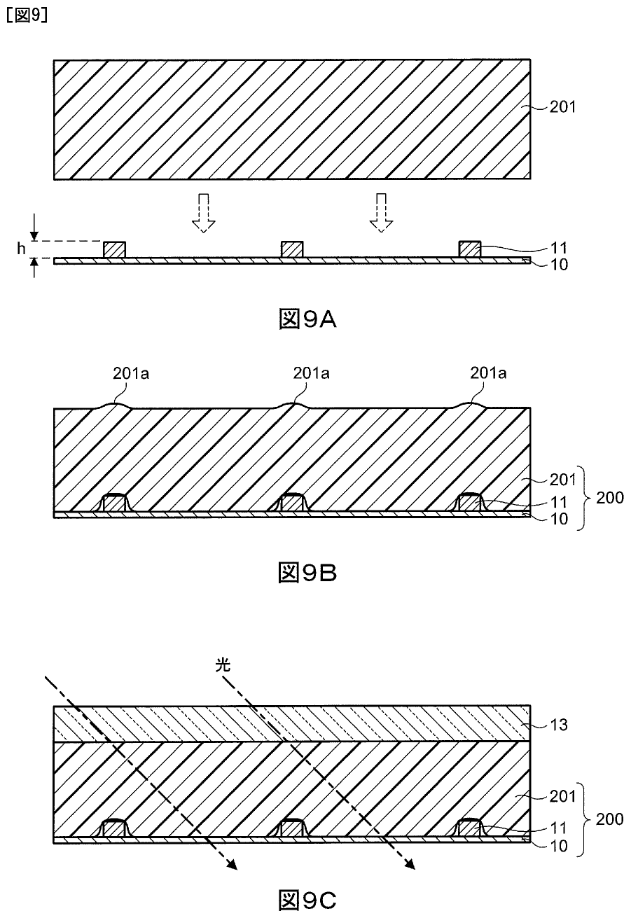

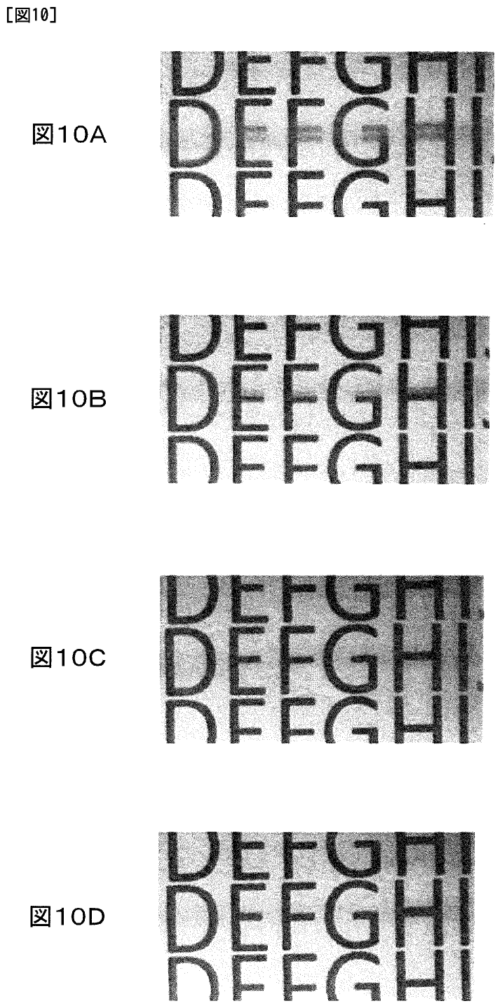

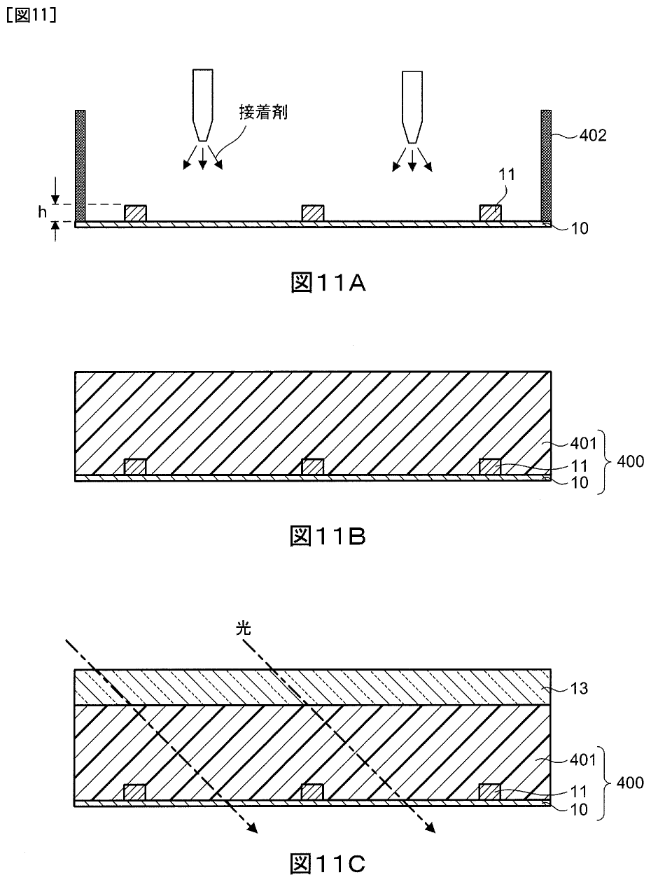

FIG. 10 illustrates an experiment result. The experiment result of FIG. 10 was obtained when heater apparatus 200 is affixed to windshield 13 of the vehicle and an image was captured using imaging unit 300 as illustrated in FIG. 7. In the experiment, the thickness of bonding layer 201 was changed. In addition, in the experiment, the elastic modulus of bonding layer 201 was set to a constant value. In addition, height h of heat wire 11 was set to 18 μm. Height h of heat wire 11 is 8 to 36 μm in general. In addition, the light incident angle to windshield 13 was set to 30°.

FIGS. 10A to 10D are diagrams illustrating captured images obtained using bonding layer 201 with thicknesses of 50 μm, 100 μm, 250 μm, and 350 μm, respectively. It shows that the greater the thickness of bonding layer 201, the smaller the distortion in a region around heat wire 11. In particular, as can be seen from FIG. 10, in the case where the thickness of bonding layer 201 is 350 μm, there is almost no distortion although the shadow of heat wire 11 can be seen. In this manner it was experimentally confirmed that it suffices to set the thickness of bonding layer 201 to 350 μm or greater. Accordingly, in heater apparatus 200 of the present embodiment, the thickness of bonding layer 201 is set to 350 μm. It should be noted that the favorable value of the thickness of bonding layer 201 changes depending on the elastic modulus of bonding layer 201, height h of heat wire 11, and the flexibility of transparent substrate 10 as described above, and therefore it suffices to set the thickness in accordance with those factors.

In short, it is preferable to set the thickness and/or elastic modulus of bonding layer 201 to a value at which the wedge angle of the protrusion formed at transparent substrate 10 in a region around heat wire 11 due to height h of heat wire 11 is 0.1° or smaller when heater apparatus 200 is affixed to the glass surface through bonding layer 201 on the basis of the height of heat wire 11 from the first surface of transparent substrate 10.

### <3> Embodiment 2

In Embodiment 1, bonding layer 201 is composed of a sheet-like adhesive agent (i.e., a double-sided tape) with a uniform thickness. The present embodiment describes an example in which bonding layer 301 is formed through coating or deposition.

FIG. 11, in which portions corresponding to FIG. 9 are denoted with the same reference numerals, is a diagram illustrating a configuration and a manufacturing process of heater apparatus 300 according to the present embodiment.

First, as illustrated in FIG. 11A, heat wire 11 is disposed on transparent substrate 10, and transparent bonding layer 401 is formed at the first surface of transparent substrate 10 so as to cover heat wire 11 as illustrated in FIG. 11B.

In the present embodiment, bonding layer 401 is formed through coating or deposition. For example, bonding layer 401 may be deposited by pouring an adhesive agent into frame 402, or bonding layer 401 may be formed through coating by using a roller (not illustrated) and the like.

Here, when bonding layer 401 has a small thickness, a protrusion corresponding to the pattern of heat wire 11 is easily formed at the surface of bonding layer 401. The formation of the above-mentioned protrusion is prevented by significantly reducing the elastic modulus of bonding layer 401, but in practice, significantly reducing the elastic modulus is not realistic.

In view of this, in the present embodiment, the formation of the protrusion corresponding to the pattern of heat wire 11 at the surface of bonding layer 401 is prevented by sufficiently increasing the thickness of bonding layer 401 as illustrated in FIG. 11B.

FIG. 11C is a diagram illustrating a state where heater apparatus 400 is affixed to windshield 13. As in FIG. 9, transparent substrate 10 is flat without being protruded to the surface side at the position of heat wire 11. As a result, as in Embodiment 1, heater apparatus 400 of the present embodiment can suppress the distortion and/or flare in the captured image in a region around heat wire 11, and can obtain a high-quality captured image.

Here, even in the case where the protrusion corresponding to the pattern of heat wire 11 is formed at the surface of bonding layer 401 in the state illustrated in FIG. 11B, when heater apparatus 400 is affixed to the glass surface through bonding layer 401, the adhesive agent corresponding to the above-mentioned protrusion portion disperses in bonding layer 401, and the pressure force does not reach the surface of transparent substrate 10, and, transparent substrate 10 is kept flat without protruding to the surface side as in Embodiment 1 since bonding layer 401 is provided with a sufficiently large thickness.

The above-mentioned embodiments are merely examples of embodiments in implementing the invention, and the technical scope of the invention should not be interpreted in a limited manner by them. In other words, the present invention can be implemented in various ways to the extent that it does not deviate from its gist or its main features.

For example, while a PET film is used as transparent substrate 10 in the embodiment, this is not limitative, and other transparent substrates may be used. The present invention is suitable for a case where a substrate with high flexibility is used as a transparent substrate.

In addition, transparent substrate 10 is preferably an anti-fogging sheet with an anti-fogging function. To obtain transparent substrate 10 as an anti-fogging sheet with an anti-fogging function, it suffices to form a hydrophilic film (anti-fogging film) of water-absorbent organic polymer or the like at the surface opposite to the surface where heat wire 11 is formed in transparent substrate 10, for example. Then, the power consumption at heat wire 11 can be effectively reduced through energization to heat wire 11 so as to assist the anti-fogging function of transparent substrate 10.

While heater apparatuses 200 and 400 of the present disclosure are used as an apparatus for suppressing frosting and fogging of windshield 13 of the vehicle in the embodiment, the heater apparatus of the embodiment of the present invention is not limited to this. Heater apparatus 200 of the present disclosure may be affixed to a transparent plastic surface instead of the glass surface. In short, the present invention is widely applicable as the heater apparatus in an image capturing apparatus that obtains a captured image by receiving image-capturing light transmitted through a heater apparatus affixed to one surface of transparent member.

This application is entitled to and claims the benefit of Japanese Patent Application No. 2019-142986 filed on Aug. 2, 2019, the disclosure each of which including the specification, drawings and abstract is incorporated herein by reference in its entirety.

### REFERENCE SIGNS LIST

10 Transparent substrate
10a, 12a, 201a Protrusion
11 Heat wire
12, 201, 401 Bonding layer
13 Windshield
100, 200, 400 Heater apparatus
300 Imaging unit
301 Image-capturing section
302 Image processing section

1. A heater apparatus with a sheet shape configured to be affixed to one surface of a transparent member, the heater apparatus comprising:
a transparent substrate;
a heat wire disposed on a first surface side of the transparent substrate; and
a bonding layer with a transparency formed on the first surface side of the transparent substrate to cover the heat wire,
wherein a thickness and an elastic modulus of the bonding layer are set to values at which a wedge angle of a protrusion is 0.1° or smaller, the protrusion being formed in a region around the heat wire at the transparent substrate due to a height of the heat wire when the heater apparatus is affixed to one surface of the transparent member through the bonding layer.

2. The heater apparatus according to claim 1,
wherein the bonding layer has a sheet shape with a uniform thickness; and
wherein the thickness and/or an elastic modulus of the bonding layer with the sheet shape is set to the values.

3. The heater apparatus according to claim 1, wherein the thickness and/or the elastic modulus of the bonding layer is set based on a height of the heat wire from the first surface of the transparent substrate.

4. The heater apparatus according to claim 1, wherein the transparent substrate is an anti-fogging sheet.

5. A vehicle image capturing apparatus comprising:
the heater apparatus according to claim 1; and
an image capturing apparatus configured to obtain a captured image by receiving image-capturing light transmitted through the heater apparatus.

6. A manufacturing method of a heater apparatus with a sheet shape configured to be affixed to one surface of a transparent member, the method comprising:
forming a heat wire on a first surface side of a transparent substrate;
forming a bonding layer with a transparency on the first surface side of the transparent substrate so as to cover the heat wire; and
affixing the transparent substrate where the heat wire and the bonding layer are formed, to one surface of the transparent member through the bonding layer,
wherein a thickness and an elastic modulus of the bonding layer are set to values at which a wedge angle of a protrusion is 0.1° or smaller, the protrusion being formed in a region around the heat wire at the transparent substrate due to a height of the heat wire when the transparent substrate where the heat wire and the bonding layer are formed is affixed to one surface of the transparent member through the bonding layer.

7. The method according to claim 6,
wherein the bonding layer is formed by affixing an adhesive agent with a sheet shape with a uniform thickness to the first surface side of the transparent substrate;
wherein in the adhesive agent with the sheet shape, a protrusion corresponding to a pattern of the heat wire is formed in a surface when the adhesive agent is affixed to the transparent substrate; and
wherein a thickness and an elastic modulus of the adhesive agent with the sheet shape are set to values at which a wedge angle of the protrusion is 0.1° or smaller, the protrusion being transferred to the transparent substrate when the transparent substrate where the heat wire and the bonding layer are formed is affixed to one surface of the transparent member through the bonding layer.

8. The method according to claim 6, further comprising forming an anti-fogging film at a surface on a side opposite to the first surface side of the transparent substrate.
